(19) United States
(12) Patent Application Publication
(10) Pub. No.: US 2006/0233262 A1
(43) Pub. Date: Oct. 19, 2006

(54) Signaling of bit stream ordering in scalable video coding

(75) Inventors: Justin Ridge, Irving, TX (US); Yiliang Bao, Irving, TX (US); Marta Karczewicz, Irving, TX (US); Xianglin Wang, Irving, TX (US); Fehmi Chebil, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/105,271

(22) Filed: Apr. 13, 2005

(51) Int. Cl. H04N 11/02; H04N 11/04; H04N 7/12; H04B 1/66

(52) U.S. Cl. 375/240.25

(57) ABSTRACT

The ordering of iterations within a video bit stream can be specified by an added syntax element. Changing the order of iteration can improve the ability to extract certain constituent elements of the video coding. In one embodiment, a method of decoding scalable video data having multiple dimensions of scalability includes receiving an indication of an ordering of iteration within a coded bit stream across the multiple dimensions and ordering iterations according to the received indication. The techniques can also be applied to encoding.

### CROSS REFERENCE TO RELATED APPLICATIONS

None.

### BACKGROUND OF THE INVENTION

1. Field of the Invention

The present invention relates generally to scalable video coding methods and systems. More specifically, the present invention relates to techniques for signaling bit stream ordering in scalable video coding.

2. description of the related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

In general, conventional video coding standards (e.g., MPEG-1, H.261/263/264) incorporate motion estimation and motion compensation to remove temporal redundancies between video frames in multimedia applications and services. Scalable video coding is a desirable feature for many multimedia applications and services used in systems employing decoders with a wide range of processing power, or where the bit rate available to decoders is not constant. Several types of video scalability schemes have been proposed, such as temporal, spatial and quality scalability. These proposed types consist of a base layer and an enhancement layer. The base layer is the minimum amount of data required to decode the video stream, while the enhancement layer is the additional data required to provide an enhanced video signal.

For each type of video scalability scheme, a particular scalability structure is defined. The scalability structure defines the relationship among the pictures of the base layer and the pictures of the enhanced layer. One type of structure is known as fine granularity scalability (FGS), which is part of the proposed scalable extension to the MPEG-4 AVC multimedia standard. The use of FGS primarily targets applications where video is transmitted over heterogeneous networks in real time. Further, FGS enables the bandwidth to be adapted by encoding content once for a range of different bit rates, which enables a video transmission server to change the transmission rate dynamically without in depth knowledge of or parsing of the video stream.

For applications utilizing scalable video coding, it is desirable to encode the video sequence once, and to be capable of extracting a portion of the bit stream in such a way that it is possible to decode the extracted portion while permitting some deterioration (e.g., lower spatial resolution, lower quality). The complexity of the extraction process is significantly impacted by the arrangement of the bit stream in video coding. Often, the bit stream arrangement makes it easy to enable one type of scalability (e.g., quality) but difficult to achieve other types of scalability (e.g., color space).

Current proposals for the H.264/AVC scalable extension have FGS quality enhancement information encoded using a series of iterations: (1) for each FGS plane, (2) for each cycle, (3) for each block, and (4) for each component. This structure makes it possible to easily extract a particular FGS plane or a cycle within the FGS plane because the extractor can count the number of FGS/cycle iterations and discard all data remaining in the slice once the appropriate iteration has been reached. Nevertheless, extracting information for a group of blocks (i.e., a spatial region) or for a particular component (e.g., luminance only) is much more difficult. Such information is considered only by the innermost iterations. As such, it is not possible to discard information from the slice.

Considering the H.264/AVC scalable extension, information from each color component (luminance/chrominance) is not collected together—luminance and chrominance values are interleaved. In some scenarios, e.g. video editing or analysis, removal of the chrominance information is desirable, but the interleaving structure makes this difficult without significantly increasing the complexity of the extraction process. Conventional systems require both luminance and chrominance values to be processed before chrominance values can be discarded.

Thus, there is a need to allow the bit stream in video coding to be tailored to the needs of an application. Further, there is a need to add a syntax element to the scalable video bit stream indicating ordering of data within a layer. Yet further, there is a need for signaling bit stream ordering in scalable video coding.

### SUMMARY OF THE INVENTION

In general, the present invention relates to scalable video coding and extracting component from the video coding where the ordering of iteration within the encoded bit stream can be dynamically changed. For example, a color component, e.g. luminance, can be extracted from the video coding after the ordering of iteration within the encoded bit stream is changed to reduce the complexity and processing required to do the extraction. The ordering of iterations within the bit stream can be specified by an added syntax element. Changing the order of iteration can improve the ability to extract certain constituent elements of the video coding.

One exemplary embodiment relates to a method of decoding scalable video data having multiple dimensions of scalability. This method can include receiving an indication of an ordering of iteration within a coded bit stream across the multiple dimensions and ordering iterations according to the received indication.

Another exemplary embodiment relates to an decoder that decodes scalable video data having multiple dimensions of scalability. This decoder can include a fine granularity scalability (FGS) enhancement module that decodes information using a series of iterations within a coded bit stream and a processor that receives a syntax element that specifies ordering of iterations in the series of iterations and instructs the FGS enhancement module to decode information using the specified ordering of iterations.

Another exemplary embodiment relates to a module that decodes scalable video data having multiple dimensions of scalability. This module can include means for receiving an indication of an ordering of iteration within a coded bit stream across the multiple dimensions and means for ordering iterations according to the received indication.

Another exemplary embodiment relates to a computer program product utilized in video decoding. This computer program product can include computer code to decode information using a series of iterations within a coded bit stream, computer code to receive a syntax element that specifies ordering of iterations in the series of iterations, and computer code to instruct the decoding of information using the specified ordering of iterations.

### BRIEF DESCRIPTION OF DRAWINGS

FIG. 1 is a block diagram of a system utilizing fine granularity scalability (FGS) quality enhancement in accordance with an exemplary embodiment.

FIG. 2 is a diagram depicting an order of iteration in accordance with an exemplary embodiment.

FIG. 3 is a diagram depicting another order of iteration in accordance with an exemplary embodiment.

FIG. 4 is a diagram depicting planes in a video frame for three color components (Y, U, V) in accordance with an exemplary embodiment.

FIG. 5 is an exemplary syntax table including parameters in accordance with an exemplary embodiment.

FIG. 6 is a flow diagram of operations performed in the signaling of bit stream ordering in accordance with an exemplary embodiment.

### DETAILED DESCRIPTION OF EXEMPLARY EMBODIMENTS

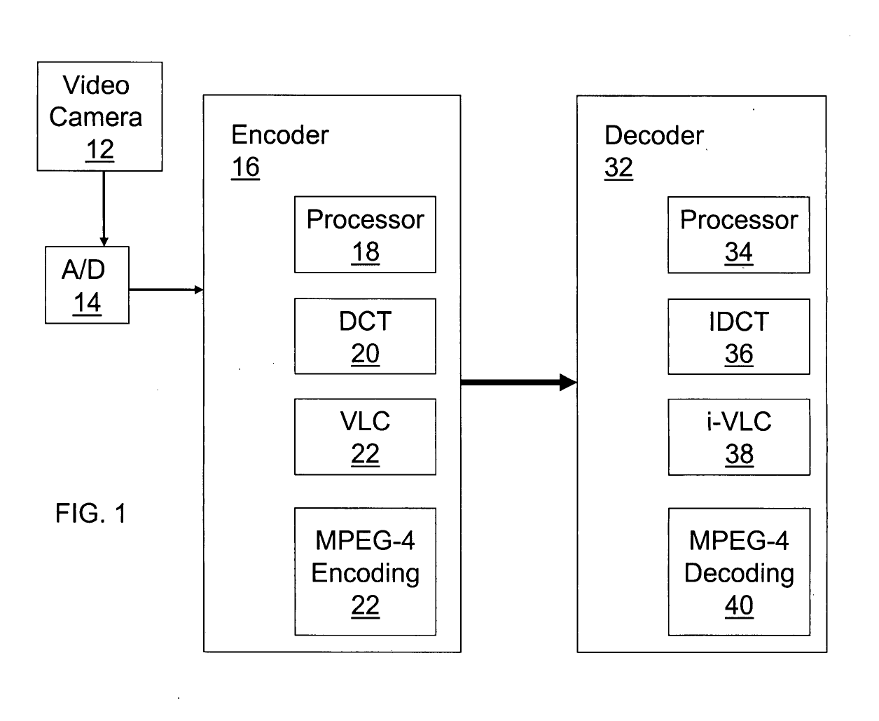

FIG. 1 illustrates a block diagram of a system utilizing fine granularity scalability (FGS) quality enhancement. A video camera 12, or other source of video signal, produces an array of pixel-representative signals that are coupled to an analog-to-digital converter 14, which is, in turn, coupled to an encoder 16 having a processor 18. The encoder 16 includes other components, such as, for example, memories, clock and timing circuitry, input/output functions, and a monitor. The encoder 16 can also include a DCT module 20, a variable length coding (VLC) encoding module 22, and a MPEG-4 ACV encoding module 24. The DCT module 20 can perform a discrete cosine transform function. These modules can be implemented in hardware, software, or a combination thereof.

The encoder 16 produces an encoded output signal, which in some embodiments can be a compressed signal requiring less bandwidth and/or memory. The encoded output signal is transmitted and eventually decoded by a decoder 32. The decoder 32 can include a processor 34, an inverse DCT module 36, an inverse VLC module 38, and a MPEG-4 AVC decoding module 40.

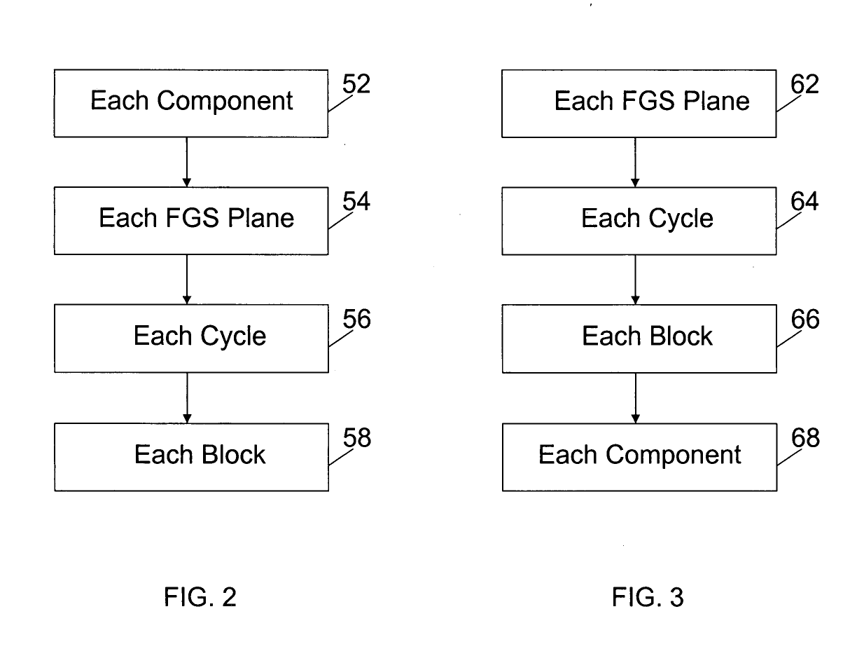

The processor 18 includes instructions to carry out an FGS quality enhancement. The FGS quality enhancement can be implemented in software using any of a variety of programming languages or, alternatively, it can be implemented in hardware or a combination of software and hardware. The FGS quality enhancement utilizes information encoded using a series of iterations performed in a certain order. FIG. 2 illustrates an order of iteration used in an exemplary FGS quality enhancement. The order of iteration includes encoding for each component (operation 52), for each FGS plane (operation 54), for each cycle (operation 56), and for each block (operation 58). This order of iteration makes the extraction of a color component (e.g., luminance only) straightforward. However, it complicates the extraction of a single FGS plane.

FIG. 3 illustrates another order of iteration used in a FGS quality enhancement. The order of iteration includes encoding for each FGS plane (operation 62), for each cycle (operation 64), for each block (operation 66), and for each component (operation 68). This order makes the extraction of a single FGS plan relatively easy, but extracting information for a group of blocks or a particular component is more computationally complex because it is not possible to discard any data from the slice.

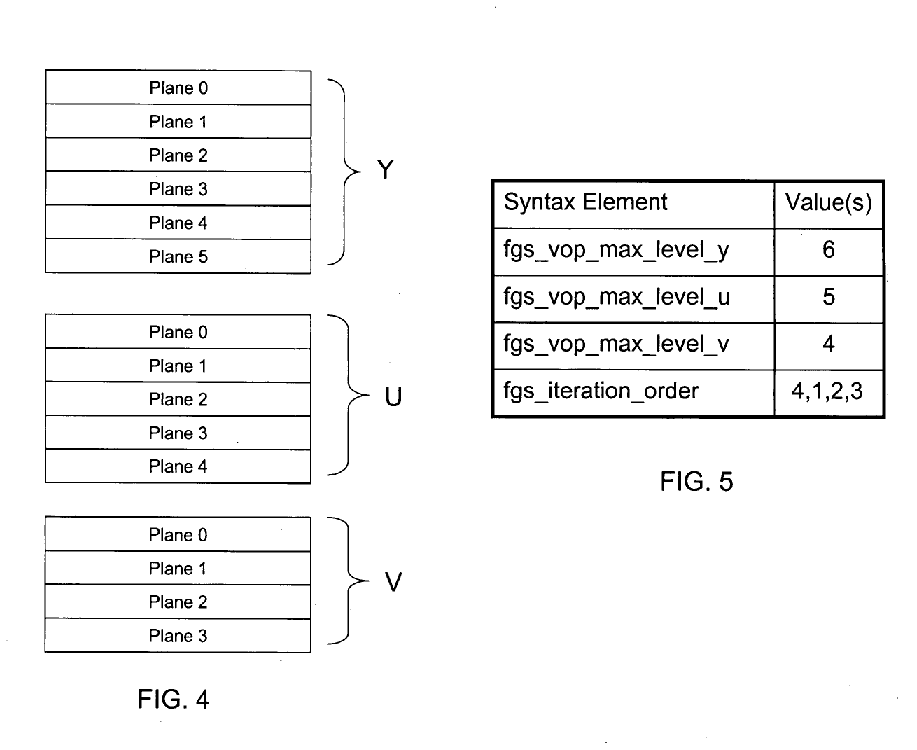

FIG. 4 illustrates planes in a video frame for three color components (Y, U, V). The three color components (Y, U, V) may have different numbers of bitplanes. In the header of each frame, there are syntax elements to indicate the maximum numbers of bitplanes for the Y, U, V components in the frame. These syntax values can be denoted as fgs_vop_max_level_y, fgs_vop_max_level_u, and fgs_vop_max_level_v.

FIG. 5 illustrates an exemplary syntax table including parameters utilized in the encoding process described herein. The syntax table includes a syntax element that specifies the ordering iteration within the bit stream. By way of example, the syntax element fgs_iteration_order can indicate 4, 1, 2, 3 to designate that components (4) are first in order, followed by FGS plane (1), cycle (2), and block (3). As such, where the syntax element fgs_iteration_order indicates 1, 2, 3, 4, the iteration order begins with FGS plane (1), followed by cycle (2), block (3), and components (4).

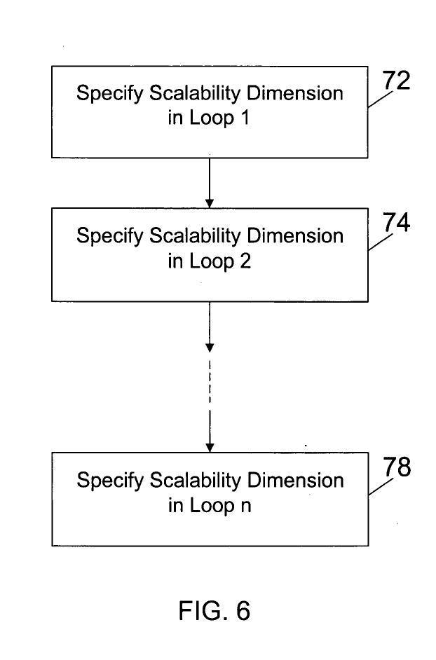

FIG. 6 illustrates operations performed in the signaling of bit stream ordering. Additional, fewer, or different operations may be performed depending on the embodiment or implementation. In an operation 72, a signal specifies which dimension of scalability is the outer iteration loop or loop number one. In an operation 74, a signal specifies which dimension of scalability is the second-most outer iteration loop or loop number two. The signaling continues until in an operation 78, a signal specifies a last iteration or loop n. Such a signaling process permits n! possible permutations, where n is the number of dimensions of scalability.

In an alternative embodiment, a finite number of allowable permutations can be determined in advance, with a signal in the bit stream indicating the index of the permutation within the allowable set. Advantageously, the ordering of iterations within bit streams can be designated such that the benefits to different orderings can be realized. The syntax element added to the scalable video bit stream indicates ordering of data within a layer such that the bit stream in video coding can be tailored to the needs of an application. As such, a component from the video coding is extracted after the ordering of iterations is determined, thereby reducing the complexity and processing required to do the extraction. For example, a color component, e.g. luminance, can be extracted from the video coding after the ordering of iteration within the encoded bit stream is changed.

While several embodiments of the invention have been described, it is to be understood that modifications and changes will occur to those skilled in the art to which the invention pertains. Accordingly, the claims appended to this specification are intended to define the invention precisely.

1. A method of decoding scalable video data having multiple dimensions of scalability, the method comprising:
receiving an indication of an ordering of iteration within a coded bit stream across the multiple dimensions; and
ordering iterations according to the received indication.

2. The method of claim 1, wherein the multiple dimensions comprise at least two from the group consisting of block, color component, cycle, and fine granularity scalability (FGS) plane.

3. The method of claim 2, wherein blocks of similar spatial location are grouped together, forming an iterative unit.

4. The method of claim 1, wherein the indication specifies order of iterations to be performed.

5. The method of claim 1, wherein a subset of permutations of the ordering of iterations is provided and the indication indicates which member of the subset is used.

6. An decoder that decodes scalable video data having multiple dimensions of scalability, the decoder comprising:
a fine granularity scalability (FGS) enhancement module that decodes information using a series of iterations within an encoded bit stream; and
a processor that receives a syntax element that specifies ordering of iterations in the series of iterations and instructs the FGS enhancement module to decode information using the specified ordering of iterations.

7. The decoder of claim 6, wherein the specified ordering of iterations comprises first, each FGS plane within the coded bit stream; second, each cycle within the coded bit stream; third, each block within the coded bit stream, and fourth, each component within the coded bit stream.

8. The decoder of claim 7, wherein the specified ordering of iterations changes based on the received syntax element, the changed specified ordering comprising first, each component within the coded bit stream; second, each FGS plane within the coded bit stream; third, each cycle within the coded bit stream; and fourth, each block within the coded bit stream.

9. The decoder of claim 6, wherein the specified ordering of iterations comprises first, each component within the coded bit stream; second, each FGS plane within the coded bit stream; third, each cycle within the coded bit stream; and fourth, each block within the coded bit stream.

10. The decoder of claim 6, wherein the ordering of iterations within an coded bit stream is across the multiple dimensions.

11. The decoder of claim 10, wherein the multiple dimensions comprise at least two from the group consisting of block, color component, cycle, and fine granularity scalability (FGS) plane.

12. A module that decodes scalable video data having multiple dimensions of scalability, the module comprising:
means for receiving an indication of an ordering of iteration within a coded bit stream across the multiple dimensions; and
means for ordering iterations according to the received indication.

13. The module of claim 12, wherein the multiple dimensions comprise at least two from the group consisting of block, color component, cycle, and fine granularity scalability (FGS) plane.

14. The method of claim 13, wherein blocks of similar spatial location are grouped together, forming an iterative unit.

15. The module of claim 12, wherein the ordering of iterations comprises first, each FGS plane within the coded bit stream; second, each cycle within the coded bit stream; third, each block within the coded bit stream, and fourth, each component within the coded bit stream.

16. The module of claim 12, wherein a subset of permutations of the ordering of iterations is provided and the indication indicates which member of the subset is used.

17. A computer program product utilized in video encoding comprising:
computer code to decode information using a series of iterations within a coded bit stream;
computer code to receive a syntax element that specifies ordering of iterations in the series of iterations; and
computer code to instruct the decoding of information using the specified ordering of iterations.

18. The computer program product of claim 17, wherein the syntax element is provided in the header of the coded bit stream.

19. The computer program product of claim 17, wherein the scalable video data has multiple dimensions of scalability and the multiple dimensions comprise at least two from the group consisting of block, color component, cycle, and fine granularity scalability (FGS) plane.

20. The computer program product of claim 19, wherein the blocks of similar spatial location are grouped together, forming an iterative unit.

21. An extractor capable of parsing a coded bit stream decodable according to the method of claim 1, wherein data to be removed by the extractor is determined by the received indication of the ordering of iteration within the coded bit stream.

22. A method of encoding scalable video data having multiple dimensions of scalability, the method comprising:
receiving an indication of an ordering of iteration within an encoded bit stream across the multiple dimensions; and
ordering iterations according to the received indication.

23. The method of claim 22, wherein the multiple dimensions comprise at least two from the group consisting of block, color component, cycle, and fine granularity scalability (FGS) plane.

24. The method of claim 23, wherein blocks of similar spatial location are grouped together, forming an iterative unit.

25. The method of claim 22, wherein the indication specifies order of iterations to be performed.

26. The method of claim 22, wherein a subset of permutations of the ordering of iterations is provided and the indication indicates which member of the subset is used.

27. An encoder that encodes scalable video data having multiple dimensions of scalability, the encoder comprising:
a fine granularity scalability (FGS) enhancement module that encodes information using a series of iterations within an encoded bit stream; and
a processor that receives a syntax element that specifies ordering of iterations in the series of iterations and instructs the FGS enhancement module to encode information using the specified ordering of iterations.

28. The encoder of claim 27, wherein the specified ordering of iterations comprises first, each FGS plane within the encoded bit stream; second, each cycle within the encoded bit stream; third, each block within the encoded bit stream, and fourth, each component within the encoded bit stream.

29. The encoder of claim 28, wherein the specified ordering of iterations changes based on the received syntax element, the changed specified ordering comprising first, each component within the encoded bit stream; second, each FGS plane within the encoded bit stream; third, each cycle within the encoded bit stream; and fourth, each block within the encoded bit stream.

30. The encoder of claim 27, wherein the specified ordering of iterations comprising first, each component within the encoded bit stream; second, each FGS plane within the encoded bit stream; third, each cycle within the encoded bit stream; and fourth, each block within the encoded bit stream.

31. The encoder of claim 27, wherein the ordering of iterations is within an encoded bit stream across the multiple dimensions.

32. The encoder of claim 31, wherein the multiple dimensions comprise at least two from the group consisting of block, color component, cycle, and fine granularity scalability (FGS) plane.

33. A module that encodes scalable video data having multiple dimensions of scalability, the module comprising:
means for receiving an indication of an ordering of iteration within an encoded bit stream across the multiple dimensions; and
means for ordering iterations according to the received indication.

34. The module of claim 33, wherein the multiple dimensions comprise at least two from the group consisting of block, color component, cycle, and fine granularity scalability (FGS) plane.

35. The method of claim 34, wherein blocks of similar spatial location are grouped together, forming an iterative unit.

36. The module of claim 33, wherein the ordering of iterations comprises first, each FGS plane within the encoded bit stream; second, each cycle within the encoded bit stream; third, each block within the encoded bit stream, and fourth, each component within the encoded bit stream.

37. The module of claim 33, wherein a subset of permutations of the ordering of iterations is provided and the indication indicates which member of the subset is used.

38. A computer program product utilized in video encoding comprising:
computer code to encode information using a series of iterations within an encoded bit stream;
computer code to receive a syntax element that specifies ordering of iterations in the series of iterations; and
computer code to instruct the encoding of information using the specified ordering of iterations.

39. The computer program product of claim 38, wherein the syntax element is provided in the header of the encoded bit stream.

40. The computer program product of claim 38, wherein the scalable video data has multiple dimensions of scalability and the multiple dimensions comprise at least two from the group consisting of block, color component, cycle, and fine granularity scalability (FGS) plane.

41. The computer program product of claim 40, wherein the blocks of similar spatial location are grouped together, forming an iterative unit.
